(19) United States
(12) Patent Application Publication
(10) Pub. No.: US 2017/0091440 A1
(43) Pub. Date: Mar. 30, 2017

(54) INFORMATION MANAGEMENT UPDATING SYSTEM

(71) Applicant: AUTHENTITY SOLUTIONS INC., Kelowna (CA)

(72) Inventor: Kevin Nichol, Kelowna (CA)

(73) Assignee: AUTHENTITY SOLUTIONS INC., Kelowna (CA)

(21) Appl. No.: 15/282,895

(22) Filed: Sep. 30, 2016

Related U.S. Application Data
(60) Provisional application No. 62/235,214, filed on Sep. 30, 2015.

(51) Int. Cl. G06F 21/45; G06F 21/60; H04L 29/06; G06F 17/30

(52) U.S. Cl. CPC G06F 21/45; G06F 17/30377; G06F 17/3056; G06F 17/30578; G06F 21/604; H04L 63/083

(57) ABSTRACT

A system and method for updating information of the user comprising a first database containing information representing a plurality of users and a user interface operable to receive an updated information of the user and a network interface adapted to access a network. The system further comprises a processing circuit operably coupled to the first database, the user interface and the network interface wherein the processing circuit is adapted to transmit to a second database through the network at least one updated record to match a corresponding record in the first database.

### CROSS REFERENCE TO RELATED APPLICATION

This application claims the benefit of priority from U.S. Provisional Patent Application No. 62/235,214 filed Sep. 30, 2015 entitled Information Management Updating System.

### BACKGROUND OF THE INVENTION

1. Field of Invention

The present invention relates generally to updating user information and in particular to a method and system for updating a user's information in a plurality of distributed databases.

2. Description of Related Art

The field of personal information is one which requires frequent updating by users. Such updating may be required when a user moves physical address or changes their phone or email contact information. Given the increasing complexity of daily life, it will be appreciated that when a person moved they may be required to update many databases containing their personal information. Such information updating may be time-consuming for the user and prone to error due to the repetition of the steps necessary to complete this update.

Conventional procedures for a user to update their contact information is for the user to log in or otherwise contact each per service provider and provide them with their updated information. This process is time-consuming and prone to error due to the need to repeat the same steps multiple times. It will also be appreciated that such systems may also be dependent upon the service provider entering the updated information in systems where it has not been directly entered by the user.

Other conventional methods of enabling a user to change their contact information in less step has been to provide a postal office with a forwarding address. Forwarding address with a mail delivery service typically intercept any mail being delivered to the old address and rerouted to the new address. However, mail forwarding services do not change the contact information which is held by each provider, but rather ensures no mail goes to the old address for the user. A user will still therefore be required to contact or otherwise update the proper contact information with each company or individual.

Some attempts have been made to provide a central database having contact information for each individual with a unique identifier for that individual which may be forwarded to each company to provide them with the updated contact information. It will be appreciated however, that such systems still require the user to forward that unique identifier to each individual or company that they wish to update. Accordingly, such systems may still be difficult and time consuming for a user to effectively update all their records. Examples of such systems may be found for example in UK Patent Application No. GB 2,5212,472.

### SUMMARY OF THE INVENTION

According to a first embodiment of the present invention there is disclosed a system for updating information of the user comprising a first database containing information representing a plurality of users and a user interface operable to receive an updated information of the user and a network interface adapted to access a network. The system further comprises a processing circuit operably coupled to the first database, the user interface and the network interface wherein the processing circuit is adapted to transmit to a second database through the network at least one updated record to match a corresponding record in the first database.

The processing circuit may be configured to access the second database through the network. The processing circuit may be configured to transmit a data file to the second database containing the at least one updated record.

The at least one updated record may overwrite a prior record in the second database.

The processing circuit may be configured to output a signal to the second database containing the at least one updated record. The second processor may receive the at least one updated record as a push notification. The system may further include a user identification system.

The processing circuit may be operably configured to accept and verify at least one password provided by the user. The processing circuit may be operably configured to access the second database and verify an account therein.

According to a further embodiment of the present invention there is disclosed a method for updating information of the user comprising storing within a first database information of a plurality of users and providing a user interface operable to receive an updated information of the user. The method further comprises accessing through a network interface, with a processing circuit a second database through the network and updating at least one record in the second database to match a corresponding record in the first database.

The method may further comprise transmitting from the processing circuit and the network interface, a data file to the second database containing the at least one updated record. The at least one updated record may overwrite a prior record in the second database.

The processing circuit may output a signal to the second database containing the at least one updated record. The system may further comprise receiving at the second database the at least one updated record as a push notification. The system may further comprise accepting and verifying at least one password provided by the user at the processing circuit.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is an illustration of a system for updating the information of a user in a plurality of distributed databases according to a first embodiment of the present invention.

FIG. 2 is a block diagram of first database of the system of FIG. 1.

FIG. 3 is a flowchart of computer steps in receiving a user's updated information for use in the system of FIG. 1.

FIG. 4 is a flowchart of computer steps in accessing one of a plurality of distributed databases to update a user's information therein for use in the system of FIG. 1.

FIG. 5 is an illustration of a system for updating the information of a user in a database from a code displayed on a user's device via an optical reader.

### DETAILED DESCRIPTION

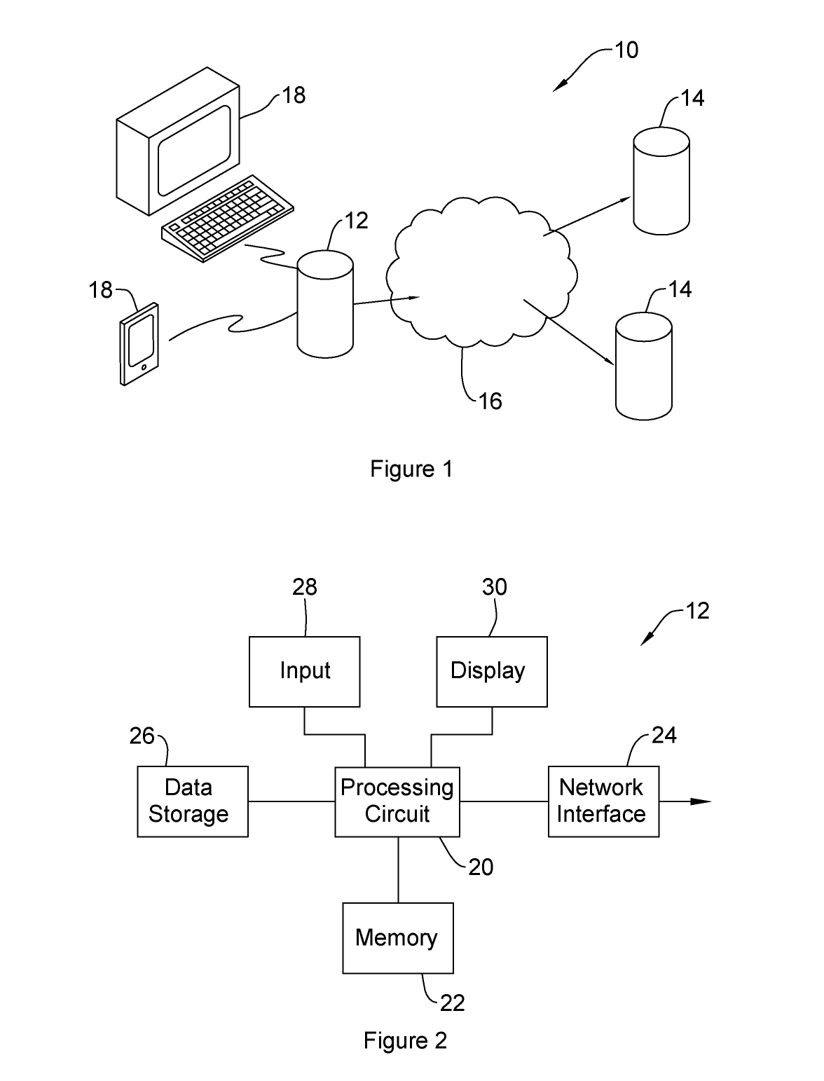

Referring to FIG. 1, a system for updating user information across a plurality of databases according to a first embodiment of the invention is shown generally at 10. The system comprises a first database 12 connected through a network to at least one second database 14. Each of the second databases is maintained and operated by a service provider with whom a user may wish to do business. The first database 12 contains current address and personal information on each user wherein the first database 12 contacts, and updates the records of each of the second databases 14 through a network 16 as updated from time to time by a user through a user device 18. It will be appreciated that the user device 18 may be any commonly known user device, such as, by way of non-limiting example, a tablet, laptop computer, smartphone, PDA, ultra-mobile PC (UMPC), desktop computer, server. etc. It will be understood that the architecture herein is provided for example purposes only and does not limit the scope of the various implementations of the communication systems and methods.

Turning now to FIG. 2, the first database 12 comprises a processing circuit 20, and memory 22 that stores machine instructions that when executed by the processing circuit 20, cause the processing circuit 20 to perform one or more of the operations and methods described herein. Processing circuit 20 may optionally contain a cache memory unit for temporary local storage of instructions, data, or computer addresses. The first database 12 further includes a data storage 26 of any conventional type operable to store a plurality of entries containing the information of a plurality of users and may optionally include an input 28 and display 30 for receiving and displaying inputs from a database manager or user. As illustrated in FIG. 2, the first database 12 also includes a network interface 24 such as a radio transmitter, ethernet adapter or the like for providing communication between the processing circuit 20 and the plurality of second databases 14 and/or user devices 18 as illustrated in FIG. 1.

More generally, in this specification, including the claims, the term “processing circuit ” is intended to broadly encompass any type of device or combination of devices capable of performing the functions described herein, including (without limitation) other types of microprocessing circuits, microcontrollers, other integrated circuits, other types of circuits or combinations of circuits, logic gates or gate arrays, or programmable devices of any sort, for example, either alone or in combination with other such devices located at the same location or remotely from each other. Additional types of processing circuit(s) will be apparent to those ordinarily skilled in the art upon review of this specification, and substitution of any such other types of processing circuit(s) is considered not to depart from the scope of the present invention as defined by the claims appended hereto. In various embodiments, the processing circuit 20 can be implemented as a single-chip, multiple chips and/or other electrical components including one or more integrated circuits and printed circuit boards.

Computer code comprising instructions for the processing circuit(s) to carry out the various embodiments, aspects, features, etc. of the present disclosure may reside in the memory 22. In various embodiments, the processing circuit 20 can be implemented as a single-chip, multiple chips and/or other electrical components including one or more integrated circuits and printed circuit boards. The processing circuit 20 together with a suitable operating system may operate to execute instructions in the form of computer code and produce and use data. By way of example and not by way of limitation, the operating system may be Windows-based, Mac-based, or Unix or Linux-based, among other suitable operating systems. Operating systems are generally well known and will not be described in further detail here.

Memory 22 may include various tangible, non-transitory computer-readable media including Read-Only Memory (ROM) and/or Random-Access Memory (RAM). As is well known in the art, ROM acts to transfer data and instructions uni-directionally to the processing circuit 20, and RAM is used typically to transfer data and instructions in a bi-directional manner. In the various embodiments disclosed herein, RAM includes computer program instructions that when executed by the processing circuit 20 cause the processing circuit 20 to execute the program instructions described in greater detail below. More generally, the term “memory” as used herein encompasses one or more storage mediums and generally provides a place to store computer code (e.g., software and/or firmware) and data that are used by the user device 18. It may comprise, for example, electronic, optical, magnetic, or any other storage or transmission device capable of providing the processing circuit 20 with program instructions. Memory 22 may further include a floppy disk, CD-ROM, DVD, magnetic disk, memory chip, ASIC, FPGA, EEPROM, EPROM, flash memory, optical media, or any other suitable memory from which processing circuit 20 can read instructions in computer programming languages.

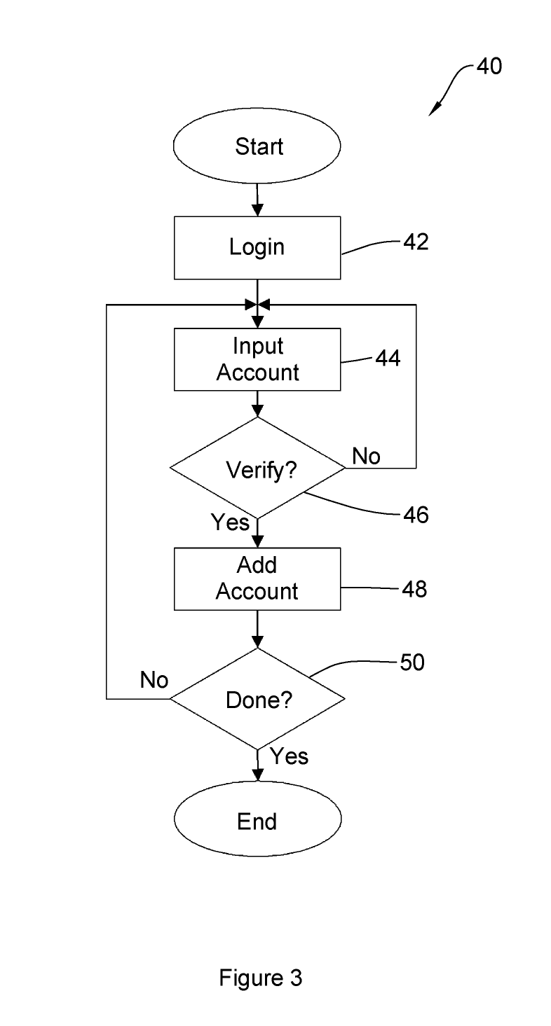

As set out above, the first database 12 stores the user information in any known format for use in updating the one or more second databases 14. In particular, as illustrated in FIG. 3, a method of receiving inputs for use in the above system is illustrated generally at 40. The method comprises receiving a log in verification from a user at step 42. The verification may comprise any known user authentication, such as, by way of non-limiting example, identification code and password, biometrics or any other known method of verifying the identity of a user. The first database 12 establishes the identify of users within the general population and authenticates users each time they access the system at step 42. The first time users access the first database 12 they are required to provide personal information that uniquely identifies them within the general population. Information such as, by way of non-limiting example, name, address and date of birth. The first database 12 optionally validates this information by redirecting the user to a third party verification step such as a third party account. After validating this information, the first database 12 may generate and retain an encrypted identifying token which it subsequently uses to identify and validate the user when the user attempts to access the first database 12. This avoids the need to request identifying information from the user more than once. The first database 12 also authenticates users each time they access the system using information submitted by the user at sign-in. Information used to authenticate a user at sign-in may include, but is not limited to, personal banking details such as a bank account number. It will be appreciated that such verification and access of the first database 12 by a user may occur through a user device 18 across a network 16 as set out above.

After a user has accessed the first database 12 containing that user's contact or other personal information, the user may then input an account with a service provider in need of such personal information in step 44. Thereafter, the first database 12 accesses the second database 14 through the network 16 using known methods to verify that the account information being provided by the user is a valid account according to known means in step 46. By way of non-limiting example the network 16 may verify the account information within the second database 14 either by directly confirming the identity of the account with the second database, confirming the account information with a further external database, by requiring additional security questions from the user or any combination of such methods. It will also be appreciated that other account confirmation methods may also be utilized. If the account information entered by a user is not valid, the first database prompts the user to re-enter the account information in step 44. If the account information is valid, the first database 12 then adds this account to the user's profile in step 48. The first database 12 then prompts the user if there are additional accounts to add in step 50. If additional accounts are to be added at that time, then steps 44 through 48 above are repeated until no further accounts are to be added to that user's profile.

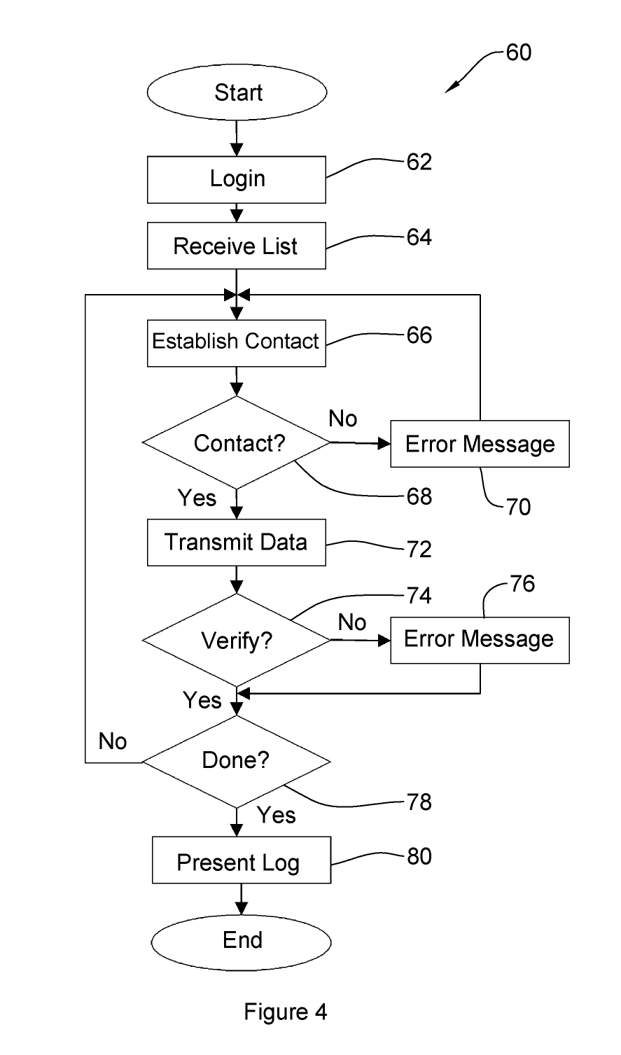

Referring now to FIG. 4, a method of updating a user's information across a plurality of second databases 14 is illustrated for use in the present system is shown generally at 60. After a user logs in to the first database 12 as set out above in step 62 (similar to step 42 above), the first database 12 accepts a list of service providers to update in step 64 (similar to step 44 above). It will be appreciated that the method of permitting a user to input such a list may be by any conventional means, such as, by way of non-limiting example, pull-down menu or checkboxes displayed to the user on the user device.

Once inputted by the user, the first database 12 attempts to establish contact with the second database 14 of one of the service providers selected in step 66. The first database 12 may communicate with the second database 14 via a common, standard API (Application Programming Interface). The second database 14 performs a passive role in this communication, receiving information from the first database 12 and responding to the requests that it receives. All instances of the second database 14 may use the same or similar implementation of the API. In particular, communication between the first database 12 and the second database 14 may be secured through the use of technologies such as, by way of non-limiting example, SSL (Secure Sockets Layer) and OAuth2.0 authentication as are known. These technologies help prevent unauthorized access to the address update functionality and services provided by the second database 14. The API enables the first database 12 to push address update information to the second database 14 and to receive confirmation responses back. The address update information is pushed via an architectural mechanism known as a ‘Web Hook’. The web hook enables the second database 14 to “listen for” update events from the first database 12 and send update success or error messages back to the first database 12. The processing circuit 20 determines if the first database 12 was successful in establishing contact with that second database 14, the processing circuit 20 then uploads the new or updated contact or other information of the user to the appropriate fields of the second database 14. If the first database 12 determines that contact has not been established in step 68, then the processing circuit 20 creates an error message for display to the user in step 70 and attempts to retry that same second database 14 or a different database in step 66 again.

After the updated information has been transmitted to the second database 14 in step 72, the processing circuit attempts to verify that the records of the second database have been updated properly in step 74. If the processing circuit 20 is unable to verify the correct updated information, the processing circuit 20 creates a message to be presented to the user in step 76 so they may be prompted to verify the records of that service provider themselves. The processing circuit 20 then determines if there are additional second databases 14 to be updated in step 78. If additional service providers are to be updated at that time, then steps 66 through 76 above are repeated until no further accounts are to be updated. At that point the processing circuit 20 may then present an error log to the user indicating which accounts were unable to be updated or verified in step 80.

Optionally, the processing circuit 20 may transmit a file containing the updated records to one or more of the second databases 14. It will be appreciated that such a file may be encrypted by any known means to prevent unauthorized access of the information located on the database. In such embodiments, the processing circuit 20 may optionally record that the message was sent or confirmed as received at the second database 14 for presentation to the user as set out above. It will be appreciated that such a data file may be organized by any known means of organizing and matching information between databases are known.

It will be appreciated that the first database 12 may include matching information for each service provider to match each entry in a user's profile to the records of that service provider to ensure that with each update of that user's profile, each updated field is provided to and updated in the correct corresponding field of the second database 14.

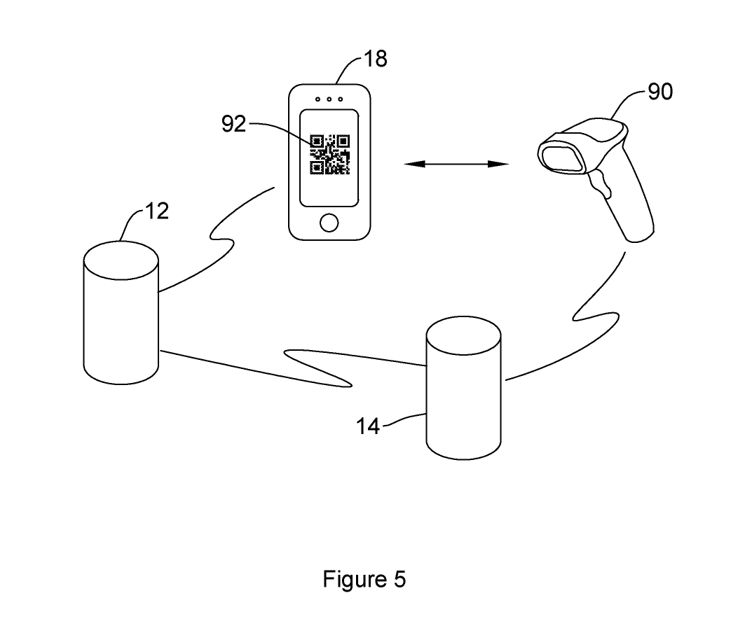

Optionally, the user's device 18 may be configured to display or transmit the information to a second database as illustrated in FIG. 5. In particular, the user's device 18 may be provided with a code or image 92, such as a bar code or QR code operable to be read by a reader 90. When a user is requested to enter their personal information, such as to enrol in a loyalty or points program, the user may display such code to be read by the reader 90. Thereafter, the second database 14 in communication with such reader 90 may retrieve the user's information from the first database 12. In particular, such code may be presented upon a mobile device, such as, by way of non-limiting example, a cellular phone or smart phone to be read by a scanner at a retailer. It will be appreciated that such a code may be presented through a separate program or application on such mobile device and may be utilized to update the records of a retailer or register the user with that retailer through providing the personal details of that user to the retailer database.

While specific embodiments of the invention have been described and illustrated, such embodiments should be considered illustrative of the invention only and not as limiting the invention as construed in accordance with the accompanying claims.

What is claimed is:

1. A system for updating information of the user comprising:
a first database containing information representing a plurality of users;
a user interface operable to receive an updated information of the user and a network interface adapted to access a network;
a processing circuit operably coupled to said first database, said user interface and said network interface,
wherein said processing circuit is adapted to transmit to a second database through said network at least one updated record to match a corresponding record in said first database.

2. The system of claim 1 wherein said processing circuit is configured to access said second database through said network.

3. The system of claim 2 wherein said processing circuit is configured to transmit a data file to said second database containing said at least one updated record.

4. The system of claim 1 wherein said at least one updated record overwrites a prior record in said second database.

5. The system of claim 1 wherein said processing circuit is configured to output a signal to said second database containing said at least one updated record.

6. The system of claim 5 wherein said second processor receives said at least one updated record as a push notification.

7. The system of claim 1 further including a user identification system.

8. The system of claim 7 wherein said processing circuit is operably configured to accept and verify at least one password provided by said user.

9. The system of claim 10 wherein said processing circuit is operably configured to access said second database and verify an account therein.

10. A method for updating information of the user comprising:
storing within a first database information of a plurality of users;
providing a user interface operable to receive an updated information of said user;
accessing through a network interface, with a processing circuit a second database through said network; and
updating at least one record in said second database to match a corresponding record in said first database.

11. The method of claim 10 further comprising transmitting from said processing circuit and said network interface, a data file to said second database containing said at least one updated record.

12. The method of claim 11 wherein said at least one updated record overwrites a prior record in said second database.

13. The system of claim 10 wherein said processing circuit outputs a signal to said second database containing said at least one updated record.

14. The system of claim 13 further comprising receiving at said second database said at least one updated record as a push notification.

15. The system of claim 10 further comprising accepting and verifying at least one password provided by said user at said processing circuit.
